(19) United States
(12) Patent Application Publication
(10) Pub. No.: US 2007/0070034 A1
(43) Pub. Date: Mar. 29, 2007

(54) Interactive entertainment system

(76) Inventors: Michael S. Fanning, Alpharetta, GA (US); Andrew M. Hepburn JR., Alpharetta, GA (US)

Correspondence Address: Eric Ringer;Smith Frohwein Tempel Greenlee Blaha LLC, P.O. Box 88148, Atlanta, GA, 30356, US

(21) Appl. No.: 11/238,944

(22) Filed: Sep. 29, 2005

(51) Int. Cl. G09G 5/00

(52) U.S. Cl. 345/156

(57) ABSTRACT

A system and a method for providing interactive entertainment are disclosed. The system includes a projectile, a target, a reader, and a controller. The projectile has a wireless actuator. The target includes a detector, which is configured to detect wireless actuators. The reader is configured to read the detected wireless actuators. The reader provides the controller with a signal when the reader detects the projectile. The controller is configured to implement a gaming module for displaying a virtual environment. The gaming module maps the detector into the virtual environment such that the detector has a virtual region of the virtual environment associated therewith, and the gaming module is configured to change at least a portion of the virtual region in response to the detector detecting the wireless actuator.

### TECHNICAL FIELD

The present invention is generally related to an interactive system for playing games and, more particularly, is related to an interactive game playing system having at least one wireless actuator.

### BACKGROUND OF THE INVENTION

Interactive entertainment devices such as “PlayStation”® by Sony Computer Entertainment, Xbox™ by Microsoft, and others are well known in the art. These systems, and others like them, generally provide a video game experience in which a player uses an input device to control a virtual player, virtual car, virtual airplane, etc., in a virtual environment. For the most part, these video games do not involve real world physical coordination by the players beyond that necessary for controlling a “joy stick” or other input device. For example, in a video game of basketball, the user might control a virtual basketball player with a joy stick, and even though the virtual basketball player is shooting a basket, the real world user is merely pressing a button. Thus, the video game experience does train the physical coordination of real world user.

More recently, various peripheral devices have emerged that connect to traditional entertainment and game platforms to provide players a more engaging physical interface to a virtual environment. Examples of such devices are Sony's “EyeToy,” dancepads from various manufacturers, and a variety of driving devices for car racing, flying and similar games. However, there is a demand for additional exciting and entertaining games that incorporate a player's real world physical activity and, in more novel applications related to the present invention, also incorporate physical objects, into a virtual environment gaming experience.

### SUMMARY OF THE INVENTION

Embodiments of the present invention provide a system and a method for interactive entertainment.

Briefly described, in architecture, one embodiment of the system, among others, can be implemented as follows. The system includes a projectile, a controller, a reader, and a target. The target has a detector, and the projectile has a wireless actuator. The detector is in communication with the reader, and the reader is configured to read the wireless actuator. The controller is in communication with the reader, and the controller configured to implement a gaming module for displaying a virtual environment. The gaming module maps the detector into the virtual environment such that the detector has a virtual region of the virtual environment associated therewith, and the gaming module is also configured to change at least a portion of the virtual region in response to the detector detecting the wireless actuator.

Embodiments of the present invention can also be viewed as employing programming embodied in computer-readable medium. In one embodiment, among others, the computer-readable medium can be broadly summarized as including logic for interfacing with a wireless reader, wherein the reader is in communication with a detector; logic for providing a virtual environment; logic for associating the detector with a virtual region of the virtual environment; and logic for changing the virtual region in response to the detector detecting a wireless actuator, wherein a projectile includes the wireless actuator.

Embodiments of the present invention can also be viewed as providing methods of interactive entertainment. In this regard, one embodiment of such a method, among others, can be broadly summarized by the following steps: providing a plurality of projectiles, each projectile having a wireless actuator; providing a target having an array of detectors, wherein the detectors are configured to detect the wireless actuators; providing a reader, wherein the reader is in communication with the detectors and is configured to read the wireless actuators; providing a virtual environment; associating each one of the readers with a virtual region of the virtual environment; and changing a given virtual region in response a given reader reading a given wireless actuator of a given projectile.

Embodiments of the present invention can also be viewed as providing a multi-zoned, wireless actuator reader that can detect the presence of a wireless actuator in one of the multiple zones.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an Interactive Entertainment System (IES) in communication with a server.

FIG. 2 is a block diagram of a target of the IES of FIG. 1.

FIG. 3 is a cross sectional view of the target of FIG. 2.

FIGS. 4A and 4B illustrate menus provided to a user of the IES.

FIG. 4C illustrates a prompt provided to a user of the IES.

### DETAILED DESCRIPTION

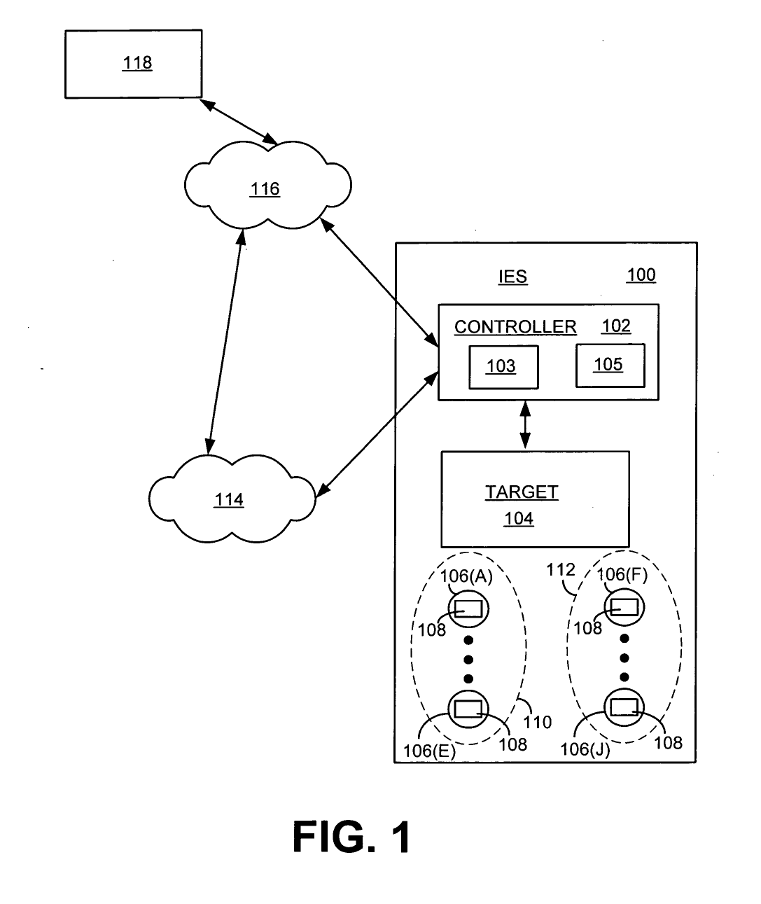

Referring to FIG. 1, an interactive entertainment system (IES) 100 includes a controller 102, target 104, and projectiles 106(A)-106(J). In some embodiments, the controller 102 is embodied in a computer system, and in other embodiments, the controller is embodied in a game-player. Computer systems and game-players are well known in the art, and consequently, the controller 102 is not discussed in detail. However, it should be noted that the controller 102 includes the hardware and software for, among other things, executing an operating system and game modules 103. In some embodiments, the controller 102 includes a display device (not shown) on which a virtual environment that corresponds to an executing game module is displayed. Furthermore, in some embodiments, the controller 102 includes an input device 105. The input device 105 can be used for, among other things, providing/updating the operating system to the controller 102 and/or providing game modules. Non-limiting examples of input devices include CD readers and DVD readers.

The modules such as, but not limited to, the game modules 103 comprise one or more ordered listings of executable instructions for implementing logical functions, which can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), a portable compact disc (CD), a portable compact disc read-only memory (CDROM) (optical), and a digital video disc (DVD). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of an embodiment of the present invention includes embodying the functionality of the preferred embodiments of the present invention in logic embodied in hardware or software-configured mediums.

In some embodiments, the controller 102 is in bi-directional communication with networks 114 and 116. Typically, the network 114 is a network such as the Internet over which logic modules, software including gaming software and operating system software, and communications may be provided to the controller 102. The network 116 is typically a network for tracking items such as an EPCglobal Network™ by EPCglobal Inc. (http://www.epcglobalinc.org). In one embodiment, the controller 102 is in communication with one of the networks and in indirect communication with the other network. For example, the controller 102 might be in communication with the network 114 and in communication with network 116 through network 114. Furthermore, the controller 102 may receive communications from one or both of the networks 114 and 116. The received communications may include, among other things, product information, digital content such as audio and/or video, and/or marketing information related to a product. Furthermore, the controller may send communications that include a variety of information, including without limitation, product and/or game information, via one or both of the networks to a server 118. The server 118 may provide the controller 102 with marketing information, product information, game information, contest information, digital content, etc.

Each one of the projectiles 106 includes a wireless actuator 108. The wireless actuators 108 are explained hereinbelow. However, it should be noted that in one embodiment, each wireless actuator 108 includes an identifier, which may be unique at least with respect to the interactive entertainment system 100. In another embodiment, the projectiles comprise multiple sets of projectiles, and the wireless actuators of a given set of projectiles may have the same identifier or at least common portions of an identifier to indicate at least one relationship among projectiles.

It should also be noted that in some embodiments, the wireless actuators may be writable. The reader can be configured to write information or encode information onto the wireless actuators via at least one of the detectors. Typically, the information is provided to the reader by the controller. However, it should be recognized that the information may have been received by the controller.

In the embodiment illustrated in FIG. 1, projectiles 106(A)-106(E) comprise a first set of projectiles 110 and projectiles 106(F)-106(J) comprise a second set of projectiles 112. Typically, in this situation, the first set of projectiles 110 are used by a first player (not shown) of the interactive entertainment system 100, and the second set of projectiles 112 are used by a second player (not shown). Players of the interactive entertainment system 100 propel their respective projectiles 106 at the target 104. The players may propel the projectiles by, among other ways imparting velocity to the projectiles by throwing, lobbing, kicking, hitting, rolling, etc., the projectiles.

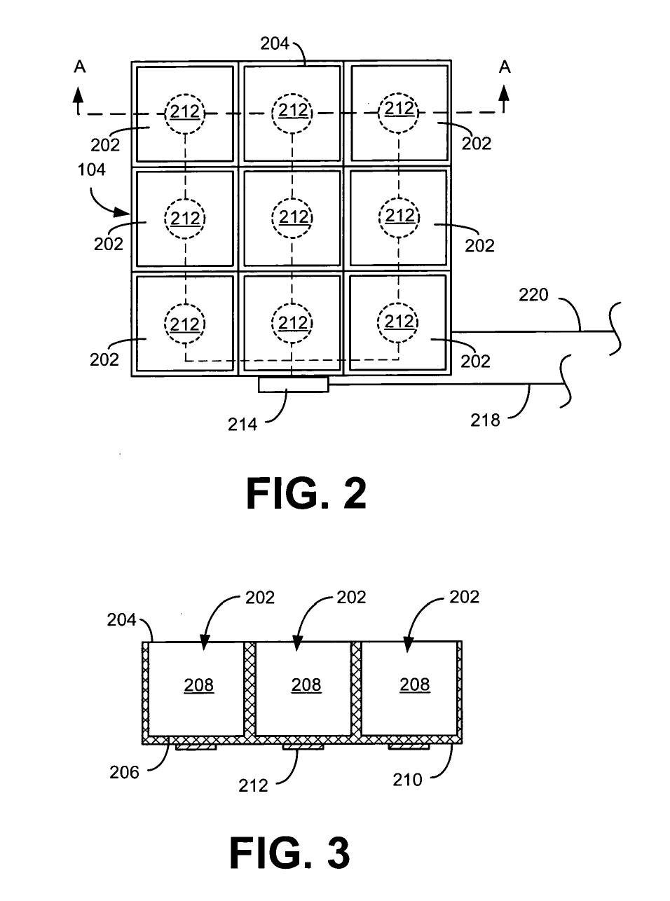

FIG. 2 illustrates the target 104 as seen from above, and FIG. 3 illustrates a cross sectional view of the target 104 as seen along the line A-A of FIG. 2. The target 104 includes a plurality of bins 202. In the embodiment illustrated, the target 104 is comprised of a 3×3 grid of bins 202. Each one of the bins 202 defines an open end 204, a bottom wall 206, and at least one sidewall 208 that extends generally upward from the bottom wall 206. Although, the bins 202 have been illustrated as having a square cross sectional shape, it should be recognized that the shape is generally a matter of design choice and that other shapes including, but not limited to, circular, oval, rectangular, are intended to be within the scope of the present invention. It should be noted that the open ends 204 are configured to be of sufficient size and shape for receiving at least one the projectiles 106. As a non-limiting example, the open-ends 204 are approximately 3 inches by 3 inches.

Furthermore, it should be noted that the embodiment illustrated in FIG. 2 and FIG. 3 is for exemplary purposes only and is a non-limiting embodiment. In other embodiments, the target may be comprised of fewer or more bins. Similarly, in other embodiments, the target can be comprised of a bin or bins having different geometries. In other embodiments, the bin or bins that comprise a target may define a periphery that is not square. Non-limiting examples of target geometries include circular, rectangular, oval, and elliptical. Furthermore, in some embodiments, a target might be comprised of multiple separable bins such that the shape of the target can be determined by the players of the IES. The bins might communicate with the reader via a wireless communication link or via a wire communication link. Furthermore, in yet some other embodiments, at least one of the bins of a target might be separable from the target and configured to communicate with the reader via a wireless communication link, and the separable bin can be used to detect both wireless actuators that are included in the IES and wireless actuators that are not included in the IES. As a non-limiting example, the separable bin can be used to read RFID transponders that are not part of the IES. Furthermore, the separable bin can be handheld and used for, among other things, reading RFID transponders affixed to items, such as consumer items.

The target 104 defines a bottom side 210, which has a plurality of detectors 212 disposed thereon. Each one of the detectors is generally aligned, approximately centered beneath, one of the bins 202. The detectors 212 are in communication with a reader 214 via electrical wiring 216. The reader 214 is in communication with the controller 102 via a link 218. In some embodiments, the link 218 is a wired communication link such as, but not limited to, a Universal Serial Bus (USB) connection, and in other embodiments, the link 218 is a wireless communication link employing wireless protocols such as, but not limited to, Bluetooth, IEEE 802.11 including 802.11a, 802.11b, and 802.11g. In some embodiments, detectors can be disposed on, or in, the side wall 208.

It should be noted that in some embodiments, the target might include only a single detector. Alternatively, the IES can be configured such that the plurality of detectors logically act as only one detector.

The detectors 212 are adapted to detect the wireless actuators 108 and provide a signal to the reader 214. In some embodiments, the reader 214 and the detectors 212 comprise a portion of a Radio Frequency Identification (RFID) system, and the wireless actuators comprise RFID transponders. When a given projectile 106 is tossed, lobbed, placed, etc. into one of the bins 202, the detector 212 beneath that given bin detects the identifier of the wireless actuator 108 of the projectile 106 in that bin. For example, if projectile 106(A) is tossed into the bin in the upper right hand corner, as illustrated in FIG. 2, then the detector underneath the bin in the upper right hand corner detects the wireless actuator 108 of the projectile 106(A). The signal from the detector, which detected the projectile, to the reader 214 includes the wireless actuator identifier. The reader 214 then provides a signal to the controller 102. The signal from the reader 214 to the controller 102 identifies the bin in which the projectile was detected and may include the identifier of the wireless actuator of the projectile that was detected. In some embodiments, instead of uniquely identifying the projectile, the signal may identify that any reader has detected a wireless actuator, that any reader has detected the set to which the projectile belongs, or the bin and the set to which the projectile belongs.

In the embodiment illustrated, the target 104 also includes an electrical wire 220 that provides electrical power to the target 104. Typically, the reader 214 and detectors 212 are powered via the electrical wire 220. Other components of the target such as, but not limited to, lights (not shown), display devices (not shown), etc. can also be powered via electrical wire 220. It should be noted that in some embodiments, electrical power can be provided via the link 218. Furthermore, it should be noted that wireless actuators may be powered or unpowered. For example, RFID transponders include both battery powered transponders and passive transponders, which are powered by the radio frequency energy emitted from detectors.

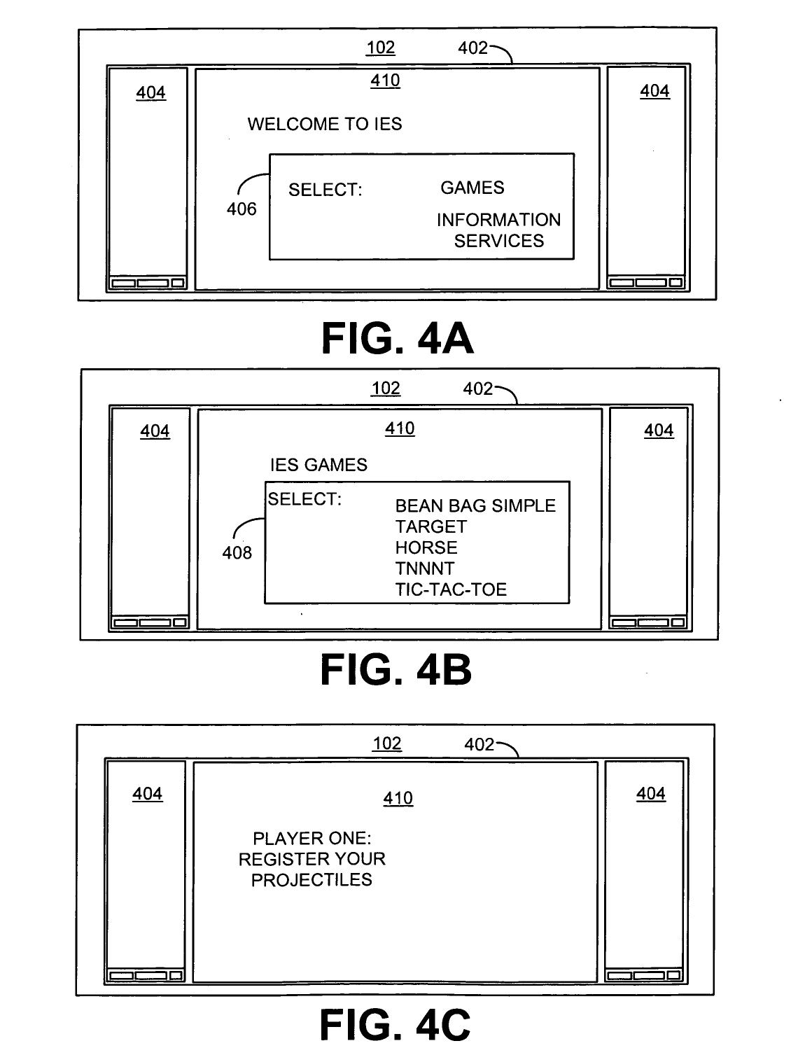

FIGS. 4A-4C illustrate an exemplary controller 102 having a display device 402. It should be remembered that in some embodiments, the controller 102 can be attached to a monitor (not shown) or a television (not shown) or other device having display capability. In some embodiments, the display device 402 displays two side panels 404 and a main panel 410. The main panel 410 may be used for, among other things, providing a video display of virtual game environments and displaying menus. The side panels 404 may be used for, among other things, displaying team and/or player information such as number of projectiles thrown or left, score, etc.

When a player starts to use the IES 100, a greeting and a first menu is 406 is displayed on the display device 402. The first menu 406 provides the player with choices such as, but not limited to, selecting to play a game or receiving information services. Information services include, but are not limited to, identifying the value of an RFID transponder so that the user can obtain further information on an object, extracting the RIFD transponder value and using that value to retrieve additional information, either from a local database or over a network, identifying/reading data encoded on the RFID transponder.

If the player selected games in the first menu, then the player is presented with a second menu 408, which is illustrated in FIG. 4B. The second menu 408 is a game menu from which the player may select which game he or she wants to play. Typically, the player is directed through chain of menus which allow the player to specify, among other things, the number of players (and/or teams); game rules such as number of points needed to win the game and/or the order in which the players/teams throw their respective projectiles, etc; and special effects to be included in the virtual environment to be displayed on the display device 402. For example, in some games such as “CATAPULT,” in the virtual environment, each team might have its own catapult for lobbing their virtual projectiles and their own virtual castles, and the special effects might include displaying virtual projectiles as fiery objects. In some embodiments, the special effects would allow the players customize their virtual castles. It should be recognized that the games played on the IES can be customizable to correspond to, among other things, marketing campaigns and/or contests. It should be noted that in some embodiments, the IES can be played in single-player mode. For example, a single-player might choose to play a game of “DARTS”. It should also be noted that in some embodiments, the IES can be configured such that a user of the IES can interact with other players via the network 114. Thus, in some embodiments, a user (or users) of the IES can play with (or against) other players who are at remote locations.

Typically, each player or team registers their respective projectiles with the controller 102. As illustrated in FIG. 4C, the controller 102 provides a prompt to the player(s) to do so. The prompt is normally provided after the player(s) has selected a game and specified the game rules. A player registers his or her projectiles by placing his or her projectiles in a bin 202 of the target 104 and the detector of that bin detects the projectiles therein. The reader 214 reads the wireless actuators of the projectiles in that bin and provides the controller 102 with the identifiers for those projectiles. The controller 102, then associates those identifiers with the player.

In one embodiment, when a player throws his or her projectile at the target 104 and misses the target 104, the detectors 212 do not detect the thrown projectile, and consequently, the reader 214 does not provide the controller 102 with a signal each time a projectile is thrown. Instead, in this embodiment, a projectile is only detected by one of the detectors when the target lands in one of the bins of the target. Because each of the projectiles are associated with a player, the controller does not need to know whose turn it is to play. Instead, the controller does nothing until it receives a signal that includes a projectile identifier eg., the identifier of the wireless actuator of the projectile, then the controller determines to whom the projectile belonged and then, among other things, adjusts that players score.

It should be remembered that the IES 100 may be in communication with the server 118 and that the server 118 can be used to provide the IES 100 with communications, game software, etc. In one embodiment, a player can register an item having a Uniform Product Code, Electronic Product Code, or similar product identifier with the IES 100. The product identifier, which might be the serial number of an RFID transponder, is then provided to the server 118, and the server 118 might then provide the IES 100 with communications related to, but not limited to, product information, contest information, marketing information, etc. In one embodiment, the server 118 automatically downloads information to the IES 100 in response to an item having an appropriate product identifier being placed in the target 104. As a non-limiting example, in the context of a contest, the server might download information to the IES 100 in response to an item having a “winning” product identifier.

If the player selects to receive information services in the first menu, then the target 104 can be transformed into variety use device. In general, the target 104 in the information services mode operates to read the value of the RFID transponder and then provide additional services or information related to that RFID transponder or the product to which it is affixed. In one embodiment, the system simply operates to read the value of any RFID transponder placed into the target 104 and display or otherwise provide this value to the user. In a more sophisticated embodiment, the system reads the value of the RFID transponder placed into the target 104 and then provides a menu of options for the user to select from, such as (a) obtaining further information about the device associated with the RFID transponder, (b) purchasing replacement parts or supplies, (c) identifying prices and locations at which a product associated with the RFID can be obtained, (d) determining if the RFID transponder value is a winning value in a sweepstake giveaway, (f) automatically ordering a product or service associated with the RFID transponder, (e) requesting a sales person to contact the user or any of a variety of other actions.

It should be appreciated that the target box may also be used to sort through multiple items or to process multiple items simultaneously. Thus, a user can place multiple objects into the target 104 and the system may react based on the various RFID transponders detected. For instance, if a collection of a related set of cereal box toys is placed in proximity to the target 104 simultaneously, the system may operate to provide the user with a set of digital content files that is unique to that combination of RFID transponders. Or, if a user places an article of clothing in proximity to the target 104, the system may operate to provide the user with the date of purchase, name of the manufacturer, brand name for the article of clothing, and a nearby store where more of that item may be purchased.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. For example, in some embodiments, the IES might include one or more games pieces and/or tokens and/or cards that can be placed on/in the target. All such modifications and variations are intended to be included herein within the scope of this disclosure and the present invention and protected by the following claims.

Therefore, having thus described the invention, at least the following is claimed:

1. A method of providing interactive entertainment, the method comprising the steps of:
providing a projectile having a wireless actuator;
providing a target having a detector configured to detect the wireless actuator;
providing a reader, wherein the reader is in communication with the detector and is configured to read the wireless actuator;
providing a virtual environment;
associating the detector with a virtual region of the virtual environment; and
changing a given virtual region in response the reader reading the wireless actuator of the projectile.

2. The method of claim 1, wherein the given region is changed from a first state to a second state for the duration of the interactive entertainment.

3. The method of claim 1, wherein the given region is changed for a predetermined period of time.

4. The method of claim 1, wherein the step of changing the given virtual region includes displaying a virtual object traversing at least a portion of the given virtual region.

5. The method of claim 1, further including the step of:
establishing a communication link with a network, wherein the network comprises a network for tracking items.

6. The method of claim 5, further including the step of:
providing product information, wherein the product information is received via the network.

7. The method of claim 5, further including the steps of:
reading a product identifier, wherein the reader reads the product identifier; and
providing the product identifier to a server via the network.

8. The method of claim 5, further including the step of:
disposing an item having the product identifier in the bin of the target.

9. The method of claim 1, wherein a plurality of projectiles are provided, each projectile having a wireless actuator, wherein the target includes a plurality of detectors, which are configured to detect the wireless actuators, wherein each detector of the plurality of detectors is associated with a virtual region of the virtual environment, and wherein a given virtual region is changed in response to a given detector reading a given wireless actuator of a given projectile.

10. A computer program, embodied in a computer readable medium, the computer program comprising:
logic for interfacing with a wireless reader, wherein the reader is in communication with a detector;
logic for providing a virtual environment;
logic for associating the detector with a virtual region of the virtual environment;
logic for changing the virtual region in response to the detector associated with the virtual region detecting a wireless actuator, wherein a projectile includes the wireless actuator.

11. The computer program of claim 10, wherein the logic for changing includes logic for displaying a virtual object traversing at least a portion of the given virtual region.

12. The computer program of claim 10, further including:
logic for establishing a communication link with a network configured to track items.

13. The computer program of claim 12, further including:
logic for displaying at least a portion of a communication received via the network, wherein the communication includes information related to an item.

14. An interactive entertainment system, the system comprising:
a projectile having a wireless actuator;
a target having a detector configured to detect the wireless actuator;
a reader in communication with the detector, wherein the reader is configured to read the wireless actuator;
a controller in communication with the reader, the controller configured to implement a gaming module for displaying a virtual environment, wherein the gaming module maps the detector into the virtual environment such that the detector has a virtual region of the virtual environment associated therewith, and wherein the gaming module is configured to change at least a portion of the virtual region in response to the detector detecting the wireless actuator.

15. The system of claim 14, wherein the detector comprises an antenna, the reader comprises a Radio Frequency Identification (RFID) reader, and the wireless actuator comprises RFID transponders.

16. The system of claim 15, wherein the target defines a plurality of bins, each bin having an open end, wherein each bin includes at least one antenna.

17. The system of claim 16, wherein each bin is defined by a bottom wall and at least one wall that extends generally outward from the bottom wall, wherein the antenna of a given bin is disposed proximal to the bottom wall of the given bin.

18. The system of claim 16, wherein each bin is defined by a bottom wall and at least one side wall that extends generally outward from the bottom wall, wherein the antenna of a given bin is disposed proximal to the at least one side wall of the given bin.

19. The system of claim 17, wherein the plurality of bins are arranged in a grid pattern.

20. The system of claim 14, further including a plurality of projectiles, wherein the plurality of projectiles includes a first set of projectiles and a second set of projectiles, wherein the gaming module is configured to associate the first set of projectiles with a first player and the second set of projectiles with a second player.

21. The system of claim 20, wherein the gaming module associates the first set of projectiles with the first player in response to the first set of projectiles being read by the reader.

22. The system of claim 14, wherein the controller is in communication with a network that is configured to track items.

23. The system of claim 22, wherein the network comprises an electronic product code network.

24. The system of claim 22, wherein the controller receives from the network a communication having product information therein.

25. The system of claim 14, wherein the projectile is propelled towards the target by a player providing the projectile with velocity.

26. The system of claim 14, wherein the projectile comprises a plurality of projectiles, each projectile having a wireless actuator, wherein the target comprises a plurality of detectors, each detector configured to detect wireless actuators, wherein the gaming module maps the array of detectors into the virtual environment such that each detector has a virtual region of the virtual environment associated therewith, and wherein the gaming module is configured to change at least a portion of a given virtual region in response to the a given detector detecting at least one wireless actuator.

27. The system of claim 14, wherein the reader is configured to write onto the wireless actuator.

28. The system of claim 14,wherein the virtual environment comprises at least one of a tic-tac-toe board, at least a portion of a catapult, at least a portion of a dart board, at least a portion of a basketball court, and at least a portion of a virtual target, wherein virtual projectiles strike the virtual target.

29. The system of claim 14, wherein the game module is configured to operate in at least one of single player mode and multi-player mode.

30. The system of claim 29, further including a plurality of projectiles, wherein the game module is configured to associate at least one projectile with a given player.
